(19) United States
(12) Patent Application Publication
(10) Pub. No.: US 2025/0204319 A1
(43) Pub. Date: Jun. 26, 2025

(54) AGRICULTURAL HARVESTER DRUM LIFT LINKAGE

(71) Applicant: CNH Industrial America LLC, New Holland, PA (US)

(72) Inventors: Jeffrey C. Trowbridge, Stevens, PA (US); Timothy Alan Meeks, Donahue, IA (US); John Bradley Wickizer, Davenport, IA (US); Niels Dybro, Muscatine, IA (US)

(21) Appl. No.: 19/002,225

(22) Filed: Dec. 26, 2024

Related U.S. Application Data
(60) Provisional application No. 63/614,784, filed on Dec. 26, 2023.

(51) Int. Cl. A01D 46/08

(52) U.S. Cl. CPC A01D 46/085

(57) ABSTRACT

A linkage assembly of an agricultural harvester includes a rigid lower link, a bendable top link, a linear actuator, and a stop. The rigid lower link, bendable top link, and linear actuator are configured to pivotally connect to a drum toolbar and to a harvester frame. The stop is configured to couple to the harvester frame, and the bendable top link is configured to bend in response to engagement with the stop to pitch the drum toolbar relative to the harvester frame. The linear actuator is configured to extend and retract to lift and lower the drum toolbar.

### CROSS-REFERENCE TO RELATED APPLICATION

This application claims priority from and the benefit of U.S. Provisional Application Ser. No. 63/614,784, entitled “AGRICULTURAL HARVESTER DRUM LIFT LINKAGE”, filed Dec. 26, 2023, which is hereby incorporated by reference in its entirety.

### BACKGROUND

The present disclosure relates generally to an agricultural harvester drum lift linkage.

Agricultural harvesters are used to harvest agricultural products (e.g., cotton or other natural material(s)). For example, an agricultural harvester may include a header having drums configured to harvest the agricultural product from a field. The agricultural harvester may also include a linkage assembly configured to lift the header for transport. In addition, as the agricultural harvester traverses a field, the agricultural harvester may encounter obstacles, such as branches or large rocks, and the linkage assembly may lift the header to position the header above such obstacles. Certain linkage assemblies include a simple four-bar linkage configured to move the header vertically between a working position and a lifted position.

### BRIEF DESCRIPTION

In certain embodiments, a linkage assembly of an agricultural harvester includes a rigid lower link, a bendable top link, a linear actuator, and a stop. The rigid lower link, bendable top link, and linear actuator are configured to pivotally connect to a drum toolbar and to a harvester frame. The stop is configured to couple to the harvester frame, and the bendable top link is configured to bend in response to engagement with the stop to pitch the drum toolbar relative to the harvester frame. The linear actuator is configured to extend and retract to lift and lower the drum toolbar.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a drum lift linkage assembly;

FIG. 2 is a side view of an embodiment of a drum lift linkage assembly having a bendable top link, in which a header is in a lowered position;

FIG. 3 is a side view of the drum lift linkage assembly of FIG. 2, in which the header is in a raised and tilted position;

FIG. 4 is a perspective view of an embodiment of a drum lift linkage assembly having two stops;

FIG. 5 is a side view of an embodiment of a drum lift linkage assembly having a lift actuator and a tilt actuator communicatively coupled to a controller; and

FIG. 6 is a perspective view of an embodiment of a drum lift linkage assembly having left and right lift actuators and left and right tilt actuators communicatively coupled to a controller.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

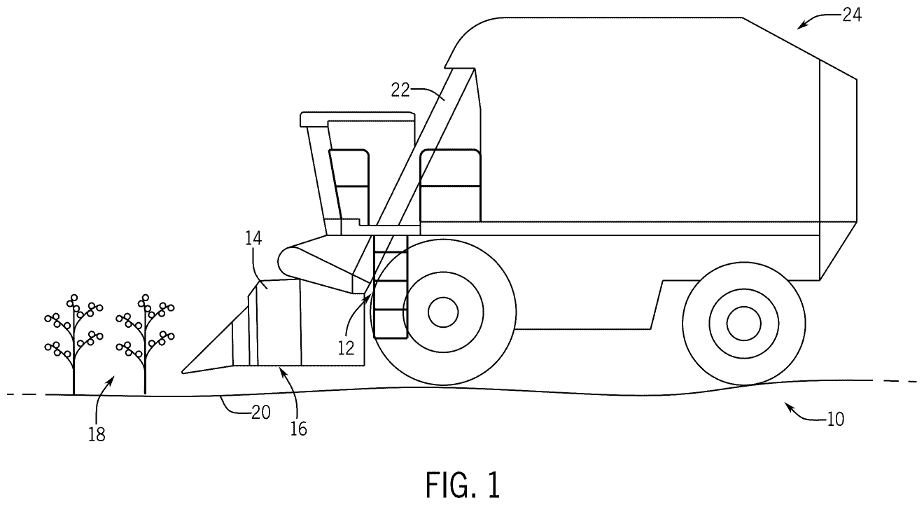

FIG. 1 is a side view of an embodiment of an agricultural harvester 10 having a drum lift linkage assembly 12. In the illustrated embodiment, the agricultural harvester 10 includes a header 14 having drums 16 configured to harvest agricultural product (e.g., cotton) 18 from a field 20. The drum lift linkage assembly 12 is configured to adjust a height and a pitch, and, in certain embodiments, a roll of the header 14.

Additionally, the agricultural harvester 10 includes an air-assisted conveying system 22 configured to move the agricultural product 18 from the drums 16 of the header 14 to an accumulator. The agricultural harvester 10 also includes a conveying system configured to convey the agricultural product 18 from the accumulator into a baler 24 (e.g., agricultural baler). The baler 24 is supported by and/or mounted within or on a harvester frame of the agricultural harvester 10. The baler 24 may form the agricultural product 18 into round bales. However, in other embodiments, the baler 24 of the agricultural harvester 10 may form the agricultural product into square bales, polygonal bales, or bales of other suitable shape(s). After forming the agricultural product 18 into a bale, a bale wrapping system of the agricultural harvester 10 may wrap the bale with a bale wrap to secure the agricultural product 18 within the bale and to generally maintain a shape of the bale.

As discussed in detail below, the agricultural harvester 10 includes a drum lift linkage assembly 12. The drum lift linkage assembly 12 includes a bendable top link, a rigid lower link, a linear actuator, and a stop. The rigid lower link is configured to pivotally connect to a drum toolbar of the header 14 and to a harvester frame of the agricultural harvester 10, the bendable top link is configured to pivotally connect to the drum toolbar and to the harvester frame, and the linear actuator is configured to pivotally connect to the drum toolbar and to the harvester frame. The linear actuator is also configured to extend and retract to lift and lower the drum toolbar. The stop is configured to couple to the harvester frame, and the bendable top link is configured to bend in response to engagement with the stop to pitch the drum toolbar relative to the harvester frame. For example, when the linear actuator is extended, the header 14 is lifted. The lifting movement of the header 14 is controlled by the rigid lower link and the bendable top link. As the header is lifted by the linear actuator, the bendable top link engages the stop, thereby causing the header 14 to tilt (e.g., pitch), which increases the ground clearance between the header 14 (e.g., the drum(s) 16 of the header 14) and the field 20. As a result, the header 14 may clear obstacles having a greater height than a header coupled to the harvester frame by a simple four-bar linkage, which may only adjust the height of the header.

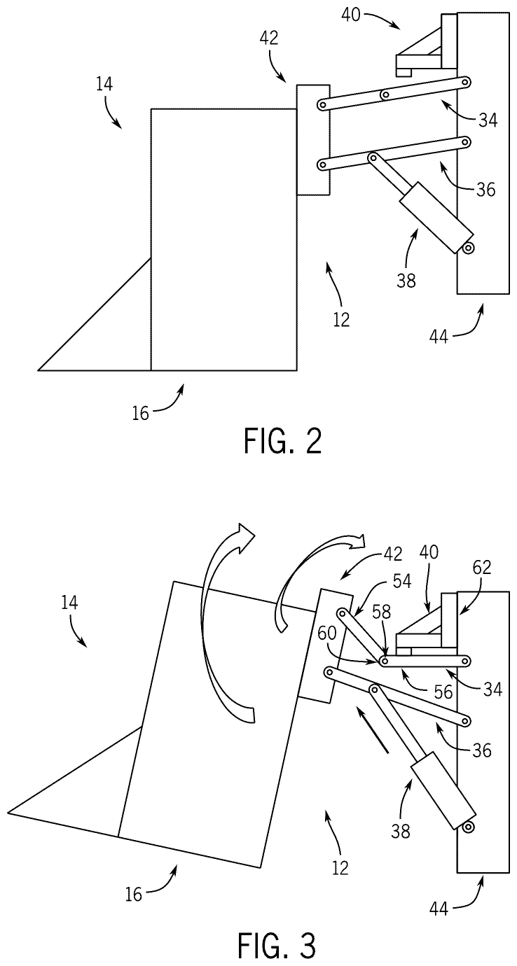

FIG. 2 is a side view of an embodiment of a drum lift linkage assembly 12 having a bendable top link 34, in which the header 14 is in a lowered position. In the illustrated embodiment, the drum lift linkage assembly 12 includes the bendable top link 34, a rigid lower link 36, a linear actuator 38, and a stop 40. In addition, the header 14 includes a drum toolbar 42 and at least one drum 16 coupled to the drum toolbar 42. The bendable top link 34 is pivotally coupled to the drum toolbar 42 of the header 14 and to the harvester frame 44 of the agricultural harvester 10. The rigid lower link 36 is pivotally coupled to the drum toolbar 42 and to the harvester frame 44. In addition, the linear actuator 38 is pivotally coupled to the rigid lower link 36 and to the harvester frame 44. While the linear actuator 38 is pivotally coupled to the rigid lower link 36 in the illustrated embodiment, in other embodiments, the linear actuator 38 may be pivotally coupled to the drum toolbar 42. Each pivotal connection may be established by a respective pivot (e.g., including shaft(s), bearing(s), bushing(s), fastener(s), other suitable component(s), or a combination thereof).

Furthermore, the stop 40 is coupled to the harvester frame 44. The stop 40 may include any suitable structure(s) configured to engage a portion of the bendable top link 34 to block rotation of the portion and enable rotation of the remainder of the bendable top link 34, thereby enabling the bendable top link 34 to bend. In certain embodiments, the stop 40 is coupled to the harvester frame 44 via suitable connection(s), such as a fastener connection, a welded connection, an adhesive connection, other suitable type(s) of connection(s), or a combination thereof. Furthermore, in certain embodiments, the stop 40 may be integrally formed with the harvester frame 44 (e.g., the harvester frame and the stop may be formed from a single piece of material).

The linear actuator 38 may include any suitable type of actuator, such as a hydraulic cylinder, a pneumatic cylinder, an electric linear actuator, etc. In the illustrated embodiment, when the linear actuator 38 is extended, the header 14 is lifted. The lifting movement of the header 14 is controlled by the rigid lower link 36 and the bendable top link 34. As the header 14 is lifted by the linear actuator 38, the bendable top link 34 engages the stop 40, thereby causing the header 14 to tilt (e.g., pitch), which increases the ground clearance between the header 14 (e.g., the drum(s) 16) and the field. As a result, the header 14 may clear obstacles having a greater height than a header coupled to the harvester frame by a simple four-bar linkage.

FIG. 3 is a side view of the drum lift linkage assembly 12 of FIG. 2, in which the header 14 is in a raised and tilted position. In certain embodiments, such as the embodiment shown in FIG. 3, the bendable top link 34 includes a first segment 54 and a second segment 56 pivotally coupled to one another at a bendable top link pivot 58. The first segment 54 is pivotally coupled to the drum toolbar 42, and the second segment 56 is pivotally coupled to the harvester frame 44. As the header 14 is being lifted by the linear actuator 38, the segments move together due to the tension force experienced by the bendable top link 34. When the second segment 56 reaches the stop 40, the motion of the second segment 56 is constrained, thereby enabling the first segment 54 to pivot about the bendable top link pivot 58, which causes the header 14 to tilt (e.g., pitch), as illustrated.

In certain embodiments, the bendable top link pivot 58 between the first segment 54 and the second segment 56 includes a damper 60. The damper 60 is configured to damp vibrations along the bendable top link 34. The damper 60 may include any suitable device(s) configured to damp vibrations, such as a bushing, a torsion spring, other suitable device(s), or a combination thereof. While the bendable top link 34 includes the damper 60 in the illustrated embodiment, in other embodiments, the damper may be omitted. Furthermore, in certain embodiments, the bendable top link may include three or more segments, in which each segment is pivotally coupled to an adjacent segment. For example, in certain embodiments, the bendable top link may include a chain. The chain may remain taught due to the tension force while the header is being lifted and bends in response to engagement with the stop.

In certain embodiments, the drum lift linkage assembly 12 includes an adjustment assembly 62 configured to adjust a position of the stop 40 relative to the harvester frame 44. For example, the adjustment assembly 62 may include a manually adjustable device, such as a screw mechanism, a pin and apertures assembly, a rachet mechanism, or another suitable device configured to facilitate adjustment of the position of the stop 40. Furthermore, in certain embodiments, the adjustment assembly 62 may include an actuator adjustable device including an actuator, such as an electric linear actuator, a hydraulic cylinder, a pneumatic cylinder, an electric motor, a hydraulic motor, a pneumatic motor, etc., configured to adjust the position of the stop relative to the harvester frame. Adjusting the position of the stop 40 relative to the harvester frame 44 controls the pitch angle of the header as a function of header height.

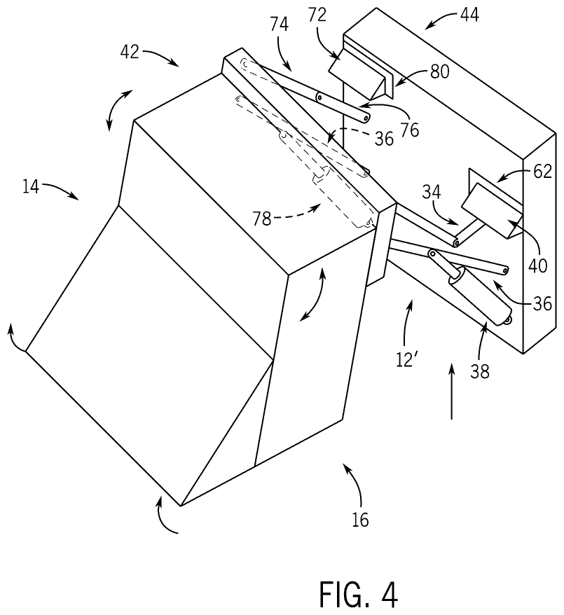

FIG. 4 is a perspective view of an embodiment of a drum lift linkage assembly 12′ having two stops. In the embodiment shown in FIG. 4, the drum lift linkage assembly 12′ includes a second stop 72 laterally offset from the first stop 40. The drum lift linkage assembly 12′ also includes a second bendable top link 74 laterally offset from the first bendable top link 34, a second rigid lower link 76 laterally offset from the first rigid lower link 36, and a second linear actuator 78 laterally offset from the first linear actuator 38. The second rigid lower link 76 is pivotally coupled to the drum toolbar 42 and to the harvester frame 44, the second bendable top link 74 is pivotally coupled to the drum toolbar 42 and to the harvester frame 44, and the second linear actuator 78 is pivotally coupled to the second rigid lower link 76 and to the harvester frame 44.

In the illustrated embodiment, the drum lift linkage assembly 12′ includes the first adjustment assembly 62 for the first stop 40 and a second adjustment assembly 80 for the second stop 72, in which the first and second adjustment assemblies are adjustable independently of one another. Accordingly, the header 14 may be adjusted in roll, in addition to height and pitch. For example, if an obstacle in the field impedes the right side of the header 14, the second stop 72 on the right side may be adjusted to a height higher than the first stop 40 on the left side, thereby causing the header to roll as the linear actuators drive the header upwardly. As a result, the header 14 may continue to harvest agricultural product on the side of the header 14 unaffected by the obstacle, thereby increasing yield.

While the drum lift linkage assembly 12′ includes two adjustment assemblies in the illustrated embodiment, in other embodiments, at least one adjustment assembly may be omitted (e.g., both adjustment assemblies may be omitted). Furthermore, in certain embodiments, at least one bendable top link (e.g., both bendable top links) may include a damper. The structures, features, functions, and variations of the rigid lower link, the bendable top link, the linear actuator, the stop, the damper, and the adjustment assembly disclosed above with reference to FIG. 3 may apply to each rigid lower link, bendable top link, linear actuator, stop, damper, and adjustment assembly disclosed with reference to FIG. 4. Furthermore, while the drum lift assembly 12′ includes two rigid lower links, two bendable top links, two linear actuators, two stops, and two adjustment assemblies in the illustrated embodiment, in certain embodiments, the drum lift assembly may include more rigid lower links, more bendable top links, more linear actuators, more stops, and more adjustment assemblies (e.g., 3, 4, 5, 6, or more).

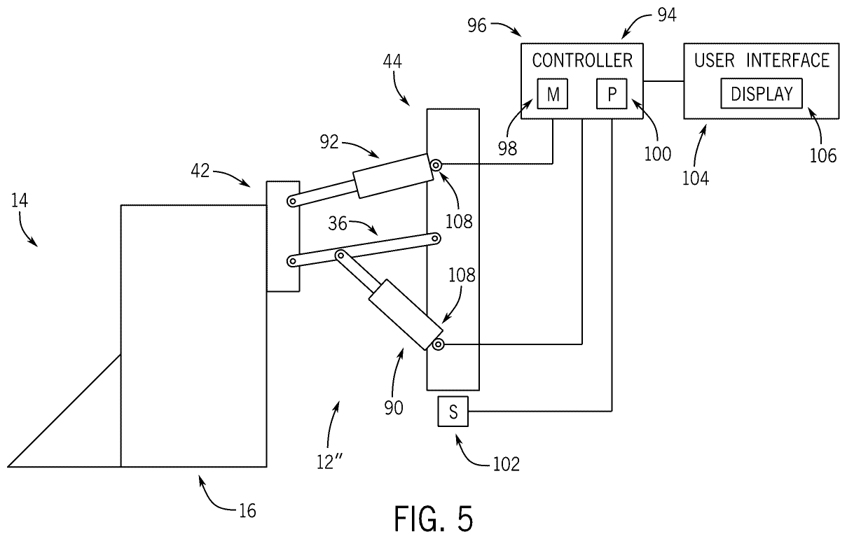

FIG. 5 is a side view of an embodiment of a drum lift linkage assembly 12″ having a lift actuator 90 and a tilt actuator 92 communicatively coupled to a controller 94. The linkage assembly 12″ also includes a rigid lower link 36 pivotally coupled to the drum toolbar 42 and to the harvester frame 44 of the agricultural harvester 10. The lift actuator 90 is pivotally coupled to the rigid lower link 36 and to the harvester frame 44. While the lift actuator 90 is pivotally coupled to the rigid lower link 36 in the illustrated embodiment, in other embodiments, the lift actuator 90 may be pivotally coupled to the drum toolbar 42. In addition, the tilt actuator 92 is pivotally coupled to the drum toolbar 42 and to the harvester frame 44. Each pivotal connection may be established by a respective pivot (e.g., including shaft(s), bearing(s), bushing(s), fastener(s), other suitable component(s), or a combination thereof).

In the illustrated embodiment, the controller 94 is part of a control system 96. The controller 94 includes a memory 98 and a processor 100, and the controller 94 is communicatively coupled to the lift actuator 90 and to the tilt actuator 92. In certain embodiments, the controller 94 is configured to control the lift actuator 90 and the tilt actuator 92 in response to detection of an obstacle in the path of the agricultural harvester. For example, the controller may receive input indicative of the presence of the obstacle from an obstacle detection sensor, from the operator through a user-interface, or from both an obstacle detection sensor and a user-interface.

In certain embodiments, the controller 94 is an electronic controller having electrical circuitry configured to control the lift actuator 90 and the tilt actuator 92 to adjust the height and pitch of the header 14. In the illustrated embodiment, the controller 94 includes a memory device 98 and a processor 100. The controller 94 may also include one or more storage devices and/or other suitable components. The processor 100 may be used to execute software, such as software for controlling the lift actuator 90 and the tilt actuator 92. Moreover, the processor 100 may include multiple microprocessors, one or more “general-purpose” microprocessors, one or more special-purpose microprocessors, and/or one or more application specific integrated circuits (ASICs), or some combination thereof. For example, the processor 100 may include one or more reduced instruction set (RISC) processors.

The memory device 98 may include a volatile memory, such as random access memory (RAM), and/or a nonvolatile memory, such as read-only memory (ROM). The memory device 98 may store a variety of information and may be used for various purposes. For example, the memory device 98 may store processor-executable instructions (e.g., firmware or software) for the processor 100 to execute, such as instructions for controlling the lift actuator 90 and the tilt actuator 92. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the lift actuator 90 and the tilt actuator 92), and any other suitable data.

In the illustrated embodiment, the control system 96 includes the obstacle detection sensor 102 communicatively coupled to the controller 94. The obstacle detection sensor 102 is configured to output a signal indicative of presence of an obstacle in a path of the agricultural harvester. The obstacle detection 102 sensor may include any suitable type(s) of sensor device(s) configured to detect an obstacle, such as a LiDAR sensor, a RADAR sensor, a camera, an infrared sensor, an ultrasonic sensor, other suitable type(s) of sensor device(s), or a combination thereof. The controller 94 is configured to control the lift actuator 90 and the tilt actuator 92 to position the header 14 above the obstacle.

In the illustrated embodiment, the control system 96 includes a user interface 104 communicatively coupled to the controller 94. The user interface 104 is configured to receive input from an operator and to provide information to the operator. The user interface 104 may include any suitable input device(s) for receiving input, such as a keyboard, a mouse, button(s), switch(es), knob(s), other suitable input device(s), or a combination thereof. In addition, the user interface 104 may include any suitable output device(s) for presenting information to the operator, such as speaker(s), indicator light(s), other suitable output device(s), or a combination thereof. In the illustrated embodiment, the user interface 104 includes a display 106 configured to present visual information to the operator. In certain embodiments, the display 106 may include a touchscreen interface configured to receive input from the operator.

In certain embodiments, the user interface 104 is configured to receive input from the operator indicative of a command to move the header. The controller 94 is configured to control the lift actuator 90 and the tilt actuator 92 based on the command. For example, the operator may command the header 14 to raise or lower, and/or the operator may command the header 14 to tilt. Furthermore, in certain embodiments, the operator may command the header 14 to establish a ground clearance sufficient to avoid an obstacle. In response, the controller 94 may control the lift and tilt actuators to raise and tilt the header to establish a ground clearance greater than the raising the header alone.

Each of the lift actuator 90 and the tilt actuator 92 may include any suitable type of actuator, such as a hydraulic cylinder, a pneumatic cylinder, an electric linear actuator, etc. In embodiments in which at least one of the lift and tilt actuators includes a hydraulic cylinder or a pneumatic cylinder, the controller 94 is communicatively coupled to the cylinder(s) via a valve assembly 108 of the control system 96. The valve assembly 108 may include any suitable number of valves and any suitable type(s) of valve(s). Furthermore, the control system 96 may include any suitable number of valve assemblies (e.g., a single valve assembly fluidly coupled to each cylinder, one valve assembly for each cylinder, etc.). The controller 94 is configured to output control signal(s) to each valve assembly, and each valve assembly is configured to adjust fluid flow (e.g., fluid pressure, fluid flow rate, etc.) to the respective cylinder(s) fluidly coupled to the valve assembly. Accordingly, the controller 94 is configured to control the cylinder(s) via the valve assembly/assemblies.

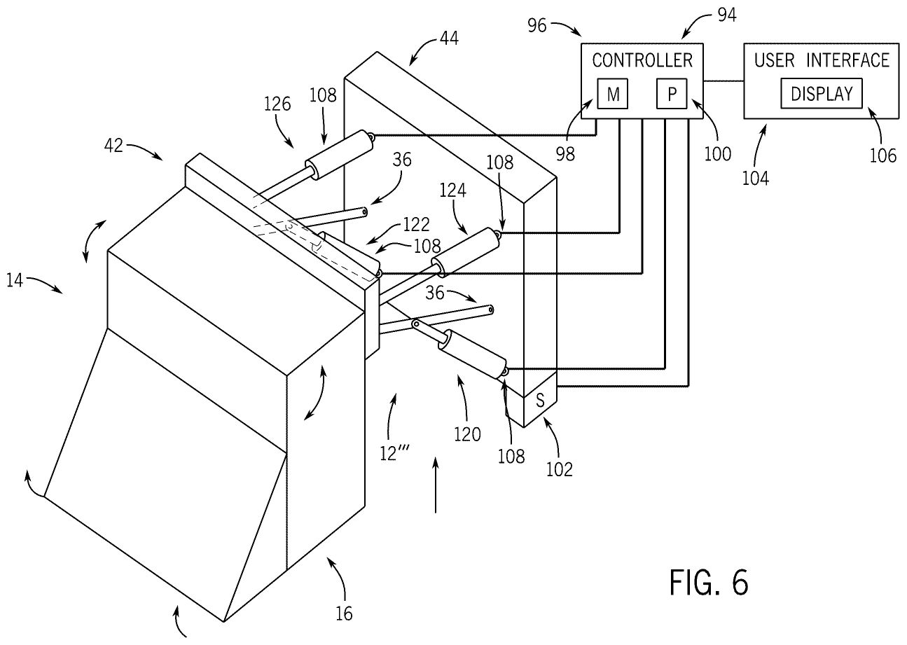

FIG. 6 is a perspective view of an embodiment of a drum lift linkage assembly 12′″ having a left lift actuator 120, a right lift actuator 122, a left tilt actuator 124, and a right tilt actuator 126 communicatively coupled to the controller 94. The left lift actuator 120 is pivotally connected to a left side of the harvester frame 44 and to a left side of the header 14 (e.g., the drum toolbar 42 of the header 14 via a rigid link 36), the right lift actuator 122 is pivotally connected to a right side of the harvester frame 44 and to a right side of the header 14 (e.g., the drum toolbar 42 of the header 14 via a rigid link 36), the left tilt actuator 124 is pivotally connected to the left side of the harvester frame 44 and to the left side of the header 14 (e.g., the drum toolbar 42 of the header 14), the right tilt actuator 126 is pivotally connected to the right side of the harvester frame 44 and to the right side of the header 14 (e.g., the drum toolbar 42 of the header 14). Furthermore, the header 14 (e.g., the drum toolbar 42 of the header 14) is coupled to the harvester frame 44 of the agricultural harvester 10 via one or more rigid links 36, and the rigid link(s) 36 are pivotally coupled to the harvester frame 44 and to the header 14 (e.g., the drum toolbar 42 of the header 14). Each pivotal connection may be established by a respective pivot (e.g., including shaft(s), bearing(s), bushing(s), fastener(s), other suitable component(s), or a combination thereof).

The controller 94 is communicatively coupled to the left lift actuator 120, to the right lift actuator 122, to the left tilt actuator 124, and to the right tilt actuator 126. The controller 94 is configured to control the left lift actuator 120, the right lift actuator 122, the left tilt actuator 124, and the right tilt actuator 126 to adjust the height of the header 14 relative to the harvester frame 44, to adjust the pitch of the header 14 relative to the harvester frame 44, and to adjust the roll of the header 14 relative to the harvester frame 44. For example, if an obstacle in the field impedes the left side of the header 14, the controller 94 may control the left lift actuator 120, the right lift actuator 122, the left tilt actuator 124, and the right tilt actuator 126 independently of one another to raise the left side of the header, thereby causing the header to roll. As a result, the header 14 may continue to harvest agricultural product on the side of the header 14 unaffected by the obstacle, thereby increasing yield.

As discussed above, the control system 96 includes the obstacle detection sensor 102 communicatively coupled to the controller 94. The obstacle detection sensor 102 is configured to output a signal indicative of presence of an obstacle in the path of the agricultural harvester. The controller 94 is configured to control the left lift actuator 120, the right lift actuator 122, the left tilt actuator 124, and the right tilt actuator 126, or a combination of the actuators, to position at least a portion of the header 14 above the obstacle. For example, if an obstacle in the field impedes both sides of the header 14, the obstacle detection sensor 102 may output a signal indicative of the presence of the obstacle. In response to the feedback from the obstacle detection sensor 102, the controller 94 may control both lift actuators and both tilt actuators to raise and tilt the header 14 to establish a ground clearance sufficient to avoid the obstacle. The tilt actuators, in combination with the lift actuators, allow adjustment of the pitch of the header 14 relative to the harvester frame 44, thereby increasing the ground clearance. As a result, the header 14 may clear obstacles having a greater height than a header coupled to the harvester frame by a simple four-bar linkage. Additionally, if an obstacle impedes the left side of the header 14, the obstacle detection sensor 102 may output a signal indicative of the presence of the obstacle. In response to the feedback from the obstacle detection sensor 102, the controller 94 may control the left lift actuator 120, the right lift actuator 122, the left tilt actuator 124, and the right tilt actuator 126 independently of one another to raise the left side of the header, thereby causing the header to roll. As a result, the header 14 may continue to harvest agricultural product on the side of the header 14 unaffected by the obstacle, thereby increasing yield.

As discussed above, the control system 96 includes the user interface 104 communicatively coupled to the controller 94. The user interface is configured to receive input from an operator indicative of a command to move the header. The controller 94 is configured to control the left lift actuator 120, the right lift actuator 122, the left tilt actuator 124, the right tilt actuator 126, or a combination thereof, based on the command. For example, the operator may command the header 14 to raise or lower, tilt, and/or roll. Furthermore, in certain embodiments, the operator may command the header 14 to establish a ground clearance sufficient to avoid an obstacle. In response, the controller 94 may control the lift actuator(s) and/or the tilt actuator(s) to raise and/or tilt the header to establish a suitable ground clearance. Additionally, in certain embodiments, the operator may command the header 14 to establish a ground clearance sufficient to avoid an obstacle that may impede one side of the header. In response, the controller 94 may control the left lift actuator 120, the right lift actuator 122, the left tilt actuator 124, and the right tilt actuator 126 independently of one another to raise, tilt, and roll the header to establish ground clearance on the side of the header 14 proximate to the obstacle. As a result, the header 14 may continue to harvest agricultural product on the side of the header 14 remote from the obstacle, thereby increasing yield.

Each of the left lift actuator 120, the right lift actuator 122, the left tilt actuator 124, and the right tilt actuator 126 may include any suitable type of actuator, such as a hydraulic cylinder, a pneumatic cylinder, an electric linear actuator, etc. In embodiments in which at least one of the lift and tilt actuators includes a hydraulic cylinder or a pneumatic cylinder, the controller 94 is communicatively coupled to the cylinder(s) via a valve assembly 108 of the control system 96. The valve assembly 108 may include any suitable number of valves and any suitable type(s) of valve(s). Furthermore, the control system 96 may include any suitable number of valve assemblies (e.g., a single valve assembly fluidly coupled to each cylinder, one valve assembly for each cylinder, etc.). The controller 94 is configured to output control signal(s) to each valve assembly, and each valve assembly is configured to adjust fluid flow (e.g., fluid pressure, fluid flow rate, etc.) to the respective cylinder(s) fluidly coupled to the valve assembly. Accordingly, the controller 94 is configured to control the cylinder(s) via the valve assembly/assemblies.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner. it is intended that such elements are not to be interpreted under 35 U.S.C. 112(f).

1. A linkage assembly of an agricultural harvester, comprising:
a rigid lower link configured to pivotally connect to a drum toolbar and to a harvester frame;
a bendable top link configured to pivotally connect to the drum toolbar and to the harvester frame;
a linear actuator configured to pivotally connect to the rigid lower link and to the harvester frame, wherein the linear actuator is configured to extend and retract to lift and lower the drum toolbar; and
a stop configured to couple to the harvester frame, wherein the bendable top link is configured to bend in response to engagement with the stop to pitch the drum toolbar relative to the harvester frame.

2. The linkage assembly of claim 1, wherein the bendable top link comprises a first segment and a second segment pivotally connected to one another, the first segment is configured to be pivotally coupled to the drum toolbar, and the second segment is configured to be pivotally coupled to the harvester frame.

3. The linkage assembly of claim 2, wherein the bendable top link comprises a damper coupled to the first segment and to the second segment, and the damper is configured to damp vibrations.

4. The linkage assembly of claim 2, wherein the second segment of the bendable top link is configured to engage the stop.

5. The linkage assembly of claim 1, comprising an adjustment assembly configured to adjust a position of the stop relative to the harvester frame.

6. The linkage assembly of claim 1, comprising:
a second rigid lower link configured to pivotally connect to the drum toolbar and to the harvester frame, wherein the second rigid lower link is laterally offset from the rigid lower link;
a second bendable top link configured to pivotally connect to the drum toolbar and to the harvester frame, wherein the second bendable top link is laterally offset from the bendable top link;
a second linear actuator configured to pivotally connect to the second rigid lower link and to the harvester frame, wherein the second linear actuator is configured to extend and retract to lift and lower the drum toolbar, and the second linear actuator is laterally offset from the linear actuator; and
a second stop configured to couple to the harvester frame, wherein the second bendable top link is configured to bend in response to engagement with the second stop to pitch the drum toolbar relative to the harvester frame, and the second stop is laterally offset from the stop.

7. The linkage assembly of claim 6, wherein the second stop is configured to be coupled to the harvester frame at a different height than the stop.

8. An agricultural harvester, comprising:
a harvester frame;
a drum toolbar configured to support a drum; and
a linkage assembly coupled to the harvester frame and to the drum toolbar and configured to lift and pitch the drum toolbar, wherein the linkage assembly comprises:
a bendable top link pivotally connected to the drum toolbar and to the harvester frame;
a rigid lower link pivotally connected to the drum toolbar and to the harvester frame;
a linear actuator pivotally connected to the rigid lower link and to the harvester frame, wherein the linear actuator is configured to extend and retract to lift and lower the drum toolbar; and
a stop coupled to the harvester frame, wherein the bendable top link is configured to bend in response to engagement with the stop to pitch the drum toolbar relative to the harvester frame.

9. The agricultural harvester of claim 8, wherein the bendable top link comprises a first segment and a second segment pivotally connected to one another, the first segment is configured to be pivotally coupled to the drum toolbar, and the second segment is configured to be pivotally coupled to the harvester frame.

10. The agricultural harvester of claim 9, wherein the bendable top link comprises a damper coupled to the first segment and to the second segment, and the damper is configured to damp vibrations.

11. The agricultural harvester of claim 9, wherein the second segment of the bendable top link is configured to engage the stop.

12. The agricultural harvester of claim 8, wherein the stop is integrally coupled to the harvester frame.

13. The agricultural harvester of claim 8, wherein the linkage assembly comprises an adjustment assembly configured to adjust a position of the stop relative to the harvester frame.

14. The agricultural harvester of claim 8, wherein the linkage assembly comprises:
a second rigid lower link pivotally connected to the drum toolbar and to the harvester frame, wherein the second rigid lower link is laterally offset from the rigid lower link;
a second bendable top link pivotally connected to the drum toolbar and to the harvester frame, wherein the second bendable top link is laterally offset from the bendable top link;
a second linear actuator pivotally connected to the second rigid lower link and to the harvester frame, wherein the second linear actuator is configured to extend and retract to lift and lower the drum toolbar, and the second linear actuator is laterally offset from the linear actuator; and
a second stop coupled to the harvester frame, wherein the second bendable top link is configured to bend in response to engagement with the second stop to pitch the drum toolbar relative to the harvester frame, and the second stop is laterally offset from the stop.

15. The agricultural harvester of claim 14, wherein the second stop is coupled to the harvester frame at a different height than the stop.

16. A control system for a header of an agricultural harvester, comprising:
a controller comprising a memory and a processor, wherein the controller is configured to control a left lift actuator, a right lift actuator, a left tilt actuator, and a right tilt actuator to adjust a height of the header relative to a harvester frame of the agricultural harvester, to adjust a pitch of the header relative to the harvester frame of the agricultural harvester, and to adjust a roll of the header relative to the harvester frame of the agricultural harvester;
wherein the left lift actuator is configured to be pivotally connected to a left side of the harvester frame and to a left side of the header, the right lift actuator is configured to be pivotally connected to a right side of the harvester frame and to a right side of the header, the left tilt actuator is configured to be pivotally connected to the left side of the harvester frame and to the left side of the header, the right tilt actuator is configured to be pivotally connected to the right side of the harvester frame and to the right side of the header, the header is configured to be coupled to the harvester frame of the agricultural harvester via a rigid link, and the rigid link is configured to be pivotally coupled to the harvester frame and to the header.

17. The control system of claim 16, comprising an obstacle detection sensor communicatively coupled to the controller, wherein the obstacle detection sensor is configured to output a signal indicative of presence of an obstacle in a path of the agricultural harvester, and the controller is configured to control the left lift actuator, the right lift actuator, the left tilt actuator, the right tilt actuator, or a combination thereof, to position at least a portion of the header above the obstacle.

18. The control system of claim 16, comprising a user interface communicatively coupled to the controller, wherein the user interface is configured to receive input from an operator indicative of a command to move the header, and the controller is configured to control the left lift actuator, the right lift actuator, the left tilt actuator, the right tilt actuator, or a combination thereof, based on the command.

19. The control system of claim 16, comprising a valve assembly, wherein each of the left and right lift actuators comprises a hydraulic cylinder configured to fluidly couple to the valve assembly, and the controller is configured to control the valve assembly to control each hydraulic cylinder independently.

20. The control system of claim 16, comprising a valve assembly, wherein each of the left and right tilt actuators comprises a hydraulic cylinder configured to fluidly couple to the valve assembly, and the controller is configured to control the valve assembly to control each hydraulic cylinder independently.
